(19) United States
(12) Patent Application Publication
(10) Pub. No.: US 2026/0019266 A1
(43) Pub. Date: Jan. 15, 2026

(54) METHODS AND DEVICES FOR USER AUTHENTICATION

(71) Applicant: Nanyang Technological University, Singapore (SG)

(72) Inventors: Milad Taleby AHVANOOEY, Singapore (SG); Jun ZHAO, Singapore (SG)

(21) Appl. No.: 19/047,573

(22) Filed: Feb. 6, 2025

(30) Foreign Application Priority Data
Jul. 12, 2024 (SG) 10202402063P

(51) Int. Cl. H04L 9/32; H04L 9/08

(52) U.S. Cl. CPC H04L 9/3228; H04L 9/0869; H04L 9/3236

(57) ABSTRACT

Methods and devices for user authentication are disclosed. In an embodiment, a user authentication method comprises: receiving a first user input indicating a user identifier; receiving a second user input indicating a hidden PIN, the hidden PIN comprising a combination of digits; verifying the hidden PIN; using the hidden PIN to retrieve an operator and a corresponding one-time valid hint item; displaying the one-time valid hint item to the user; receiving a third user input indicating a transformed hidden passcode, the transformed hidden passcode comprising a combination of symbolic items; and authenticating the user if the transformed hidden passcode corresponds to a stored hidden passcode transformed by the operator, wherein the stored hidden passcode is associated with the user identifier.

### CROSS REFERENCE TO RELATED APPLICATION

The present application claims priority from Singapore Patent Application No. 10202402063P filed on Jul. 12, 2024, and entitled “WEB3U2D: A GENERATIVE AI-BASED DYNAMIC AND TYPELESS USER-TO-DEVICE AUTHENTICATION SCHEME FOR SECURING WEB 3.0 PLATFORMS”, the entire disclosure of which is incorporated herein by reference.

### TECHNICAL FIELD

The present disclosure relates to user authentication. In particular, the present disclosure relates to user to device authentication.

### BACKGROUND

Web 3.0 is the core engine of the next-generation Internet, which provides a decentralized online ecosystem (e.g., Metaverse or crypto wallets) by applying blockchain and distributed ledger technologies through the Internet of Everything (IoE) environments where users would have anonymous control and ownership over their financial and web surfing activities. Due to exchanging the exponential number of financial assets in Web 3.0 decentralized and sensitive applications (hereafter referred to as (D)Apps) as well as the untraceable nature of transactions (except for a few cryptocurrencies), they are attractive targets for attackers to design adversarial attacks (e.g., keylogging and downfall data-leaking).

Nevertheless, attackers can steal user-to-device (U2D) credentials (e.g., passwords or PINs) by performing a successful adversarial attack. Once a user's verifiable factors are stolen, attackers could reuse them to impersonate him/her to bypass the U2D security protocol from anywhere remotely. To overcome this issue, (D)Apps require users to prove the ownership of a device and to enter knowledge-based factors or biometrics that are difficult to steal in normal scenarios. This U2D security scheme is known as two-factor authentication (2FA), in which a knowledge-based combination (e.g., PIN or password) or biometrics factor serves as a primary factor and a hardware security token (or a phone) as a secondary factor. If the secondary factor is an external physical security key token, the scheme is called Universal 2^{nd} Factor (U2F), a strong industry standard of the 2FA. Some recent studies highlighted that while the 2FA does not completely prevent account compromise remotely, it mitigates the likelihood and influence of a successful remote attack. On the other hand, there are circumstantial scenarios that may cause a device to be infected by spyware, and/or U2D interactions are collected and sent to a command & control (C&C) remote server, i.e., the Atomic wallet encountered a massive infrastructure breach that led to an immense loss of over $100 million in cryptocurrency in June 2023.

The problem of exposing verifiable credentials and/or encrypted secret keys is still an ongoing issue in the IoE devices that allows the attackers to craft various forms of active adversarial attacks such as phishing, spyware, camera recording, and shoulder surfing and stealing them to bypass U2D security protocols. Technically, such security flaws could be enabled by data leaking vulnerabilities in CPUs (e.g., Downfall and Inception) so that cyberattacks can take advantage to steal victims' credentials covertly through their devices.

Users often set the SMS-based one-time passcode (OTP) via a phone number, email-based OTP verification, or time-based OTP via specific software (e.g., Google Authenticator) as a secondary authentication factor in (D)Apps, as well as keep email accounts logged into browsers on their devices, which increases the risk of credential exposure that can be stolen by malware. For example, if an adversary performs an advanced persistent threat (APT) by installing a Remote Access Trojan (RAT) spyware on the victim device and successfully captures the primary factor and steals the secondary factor, then (s)he can compromise the account of a user in (D)Apps remotely, which may lead to bypassing the 2FA since the two required factors are available in such a scenario (except for an external security token). Still, the single-factor authentication (SFA)-based PIN/Passcode scheme is deployed to secure some digital banking services (e.g., debit/credit card) and cryptocurrency wallets. This is also an alternative mechanism for biometric-based approaches on IoE machines such as smartphones and smart doors. In addition to the SFA-based methods, multi-factor authentication (MFA) such as 2FA and U2F, and their combination with knowledge-based and biometrics-based schemes are commonly deployed U2D protocols in sensitive (D)Apps, which require a user to enter more than one independent factor to verify her/his access to an account. Although these approaches provide safer mechanisms than SFA algorithms, they also suffer from two or more verifiable factors that are difficult to steal, but it is still possible if an attacker successfully installs a RAT spyware on the victim's device.

### SUMMARY

According to a first aspect of the present disclosure, a user authentication method is provided. The user authentication method comprises: receiving a first user input indicating a user identifier; receiving a second user input indicating a hidden PIN, the hidden PIN comprising a combination of digits; verifying the hidden PIN; using the hidden PIN to retrieve an operator and a corresponding one-time valid hint item; displaying the one-time valid hint item to the user; receiving a third user input indicating a transformed hidden passcode, the transformed hidden passcode comprising a combination of symbolic items; and authenticating the user if the transformed hidden passcode corresponds to a stored hidden passcode transformed by the operator, wherein the stored hidden passcode is associated with the user identifier.

Methods and devices of the present disclosure provide a decentralized and dynamic U2D authentication scheme, which functions based on user's settings saved on the device and does not need a centralized party (e.g., cloud server) for generating the one-time valid code like two 2FA and U2F schemes.

In an embodiment, using the hidden PIN to retrieve an operator and a corresponding one-time valid hint item comprises using the hidden PIN to generate an extraction secret key and using the extraction secret key to extract a set of operators and set of corresponding hint items and selecting the operator from the set of operators and the corresponding one-time valid hint item from the set of corresponding hint items.

In an embodiment, using the hidden PIN to generate the extraction secret key comprises using the hidden PIN as a hash secret key to hash the user identifier and using the hashed user identifier as the extraction secret key.

In an embodiment, the set of operators and the set of corresponding hint items are embedded as Unicode zero-width characters inside a hash value.

In an embodiment, selecting the operator from the set of operators and the corresponding one-time valid hint item from the set of corresponding hint items comprises considering past states of user authentication.

In an embodiment, considering past states of user authentication comprises using a Long Short-Term Memory (LSTM) based hint generator.

In an embodiment, considering past states of user authentication comprises using a Generative-Decision Tree-based attention mechanism.

In an embodiment, the method further comprises generating a set of lists of randomized digits and wherein the second user input comprises a set of indications of an ith item in each list of the set of lists wherein it corresponds to a digit of the hidden PIN.

In an embodiment, the method further comprises displaying an indication of the operator to the user in response to a user interaction with the displayed hint.

According to a second aspect of the present disclosure, a non-transitory computer readable carrier medium carrying processor executable instructions operable to cause a processor to carry out a method set out above is provided.

According to a third aspect of the present disclosure, user authentication device comprising a processor, and program storage is provided. The program storage stores computer program instructions operative by the processor to: receive a first user input indicating a user identifier; receive a second user input indicating a hidden PIN, the hidden PIN comprising a combination of digits; verify the hidden PIN; use the hidden PIN to retrieve an operator and a corresponding one-time valid hint item; display the one-time valid hint item to the user; receive a third user input indicating a transformed hidden passcode, the transformed hidden passcode comprising a combination of symbolic items; and authenticate the user if the transformed hidden passcode corresponds to a stored hidden passcode transformed by the operator, wherein the stored hidden passcode is associated with the user identifier.

In an embodiment, the program storage further stores computer program instructions operative by the processor to: use the hidden PIN to retrieve an operator and a corresponding one-time valid hint item by using the hidden PIN to generate an extraction secret key and using the extraction secret key to extract a set of operators and set of corresponding hint items and selecting the operator from the set of operators and the corresponding one-time valid hint item from the set of corresponding hint items.

In an embodiment, using the hidden PIN to generate the extraction secret key comprises using the hidden PIN as a hash secret key to hash the user identifier and using the hashed user identifier as the extraction secret key.

In an embodiment, the set of operators and the set of corresponding hint items are embedded as Unicode zero-width characters inside a hash value.

In an embodiment, selecting the operator from the set of operators and the corresponding one-time valid hint item from the set of corresponding hint items comprises considering past states of user authentication.

In an embodiment, considering past states of user authentication comprises using a LSTM-based hint generator.

In an embodiment, considering past states of user authentication comprises using a Generative-Decision Tree-based attention mechanism.

In an embodiment, the program storage further stores computer program instructions operative by the processor to: generate a set of lists of randomized digits and wherein the second user input comprises a set of indications of an ith item in each list of the set of lists wherein it corresponds to a digit of the hidden PIN.

In an embodiment, the program storage further stores computer program instructions operative by the processor to: display an indication of the operator to the user in response to a user interaction with the displayed hint.

### BRIEF DESCRIPTION OF THE DRAWINGS

In the following, embodiments of the present invention will be described as non-limiting examples with reference to the accompanying drawings in which:

FIG. 1 is a block diagram showing a user authentication device according to an embodiment of the present invention;

FIG. 2 is a flow chart showing a method of registering a user with an authentication device according to an embodiment of the present invention;

FIG. 3 shows a screen display of a user authentication device according to an embodiment of the present invention during user registration;

FIG. 4 is a table showing a list of default password options used in an embodiment of the present invention;

FIG. 5 is a table showing a default list of hint items and operators used in an embodiment of the present invention;

FIG. 6 is a flow chart showing a user authentication method according to an embodiment of the present invention;

FIG. 7 shows a screen display of a user authentication device according to an embodiment of the present invention during user authentication;

FIG. 8 shows a generative AI hint validator used in embodiments of the present invention;

FIG. 9 shows an overview of the entry of hidden PIN and hidden passcode information in an embodiment of the present invention;

FIG. 10 is a table showing the authentication process for a first user;

FIG. 11 shows two lists of one-time valid randomized options generated based on the first user's settings;

FIG. 12 is a table showing the authentication process for a second user;

FIG. 13 shows two lists of one-time valid randomized options generated based on the second user's settings;

FIG. 14 is a table showing a comparison of Adversarial attack resistance score for different authentication methods; and

FIG. 15 is a table showing a comparison of scores for different authentication methods.

### DETAILED DESCRIPTION

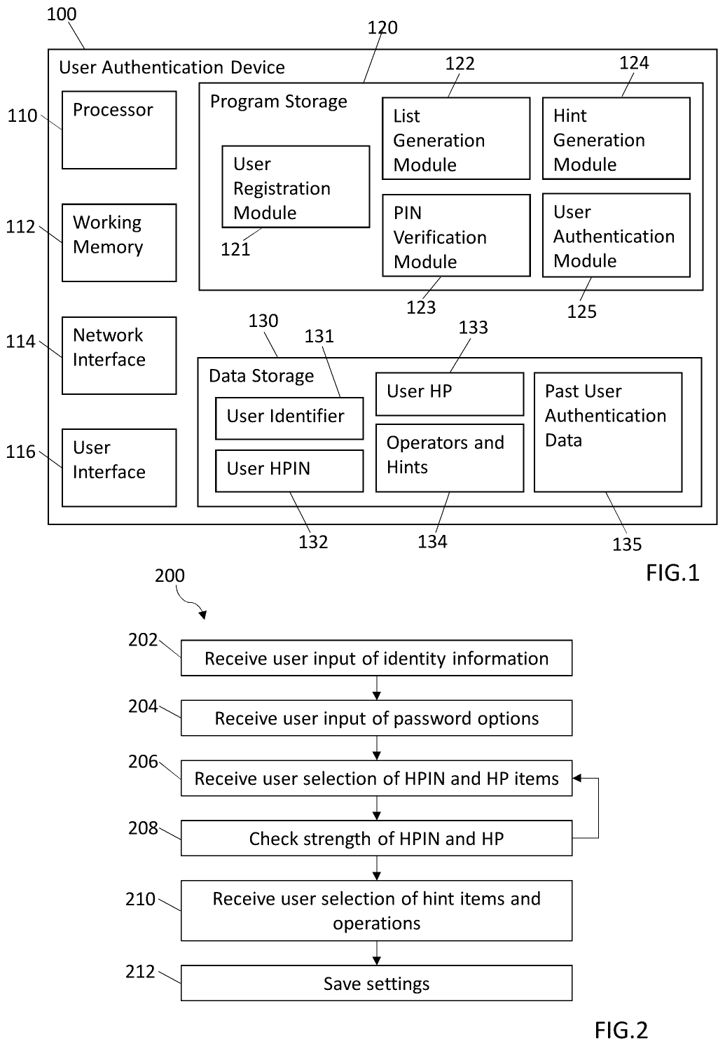

FIG. 1 is a block diagram showing a user authentication device according to an embodiment of the present invention. The user authentication device 100 comprises a processor 110, a working memory 112, a network interface 114, a user interface 116, program storage 120, and data storage 130. The processor 110 may be implemented as one or more central processing unit (CPU) chips. The program storage 120 is a non-volatile storage device such as a hard disk drive which stores computer program modules. The computer program modules are loaded into the working memory 112 for execution by the processor 110. The data storage 130 is a non-volatile storage device which stores data which is used by the user authentication device 100 during processing. The network interface 114 is an interface that allows the user authentication device 100 to communicate with other devices. The user interface 116 may be implemented as a touch screen which allows a user to input various user inputs during user authentication processing by the user authentication device 100.

The program storage 120 stores a user registration module 121, a list generation module 122, a PIN verification module 123, a hint generation module 124, and a user authentication module 125. The computer program modules cause the processor 110 to execute various processing methods which are described in more detail below. The program storage 120 may be referred to in some contexts as computer readable storage media and/or non-transitory computer readable media. As depicted in FIG. 1, the computer program modules are distinct modules which perform respective functions 15 implemented by the user authentication device 100. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while the software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

In some embodiments, the user authentication device 100 is a computing device such as a smart phone, a tablet computer, or a personal computer. In such embodiments, user authentication may be conducted to allow a user access to the device itself. In other embodiments, the user authentication device 100 is implemented as a server which controls access to a website or online computing resource. In such embodiments, although the user authentication device 100 is described with reference to a computer, it should be appreciated that the user authentication device 100 may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the user authentication device 100 to provide the functionality of a number of servers that is not directly bound to the number of computers in the user authentication device 100. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

The data storage 130 stores user identifier data 131, user hidden personal identification number (HPIN) data 132, user hidden password (HP) data 133, operators and hints 134 and past user authentication data 135. Here, we developed an encoding-storing procedure, which creates the hash values of HPIN and HP using the KMAC256 algorithm (FIPS 202), by applying the HPIN as the key. Then, it generates a hidden string of Unicode zero-width characters according to the password settings: Lₕᵢ, Lₕₒ, and Lₚₒ by deploying the HPIN as the secret key when performing the steganography algorithm. Then, it stores the crafted hash values and a hidden string of password settings into a local database or a server considering the Web 2.0 or Web 3.0 applications.

The user authentication device 100 requires a user to set and memorize a 4-digit hidden PIN (HPIN) as the first combination during the registration phase. The knowledge of HPIN will be used by user to find a one-time valid Dynamic PIN (DPIN) by picking the ith items from four lists of randomized digits (e.g., 0, . . . , 9) during every authentication attempt. Also, (s)he must set a hidden password (HP), which contains 4-symbolic items (e.g., words, letters, or emojis). When the DPIN is verified successfully, the user authentication device 100 will perform a fine-tuned LSTM-based hint generator for creating a one-time valid hint (OVH) item.

The user authentication device 100 requires the user to set at least five pairs of hint items (e.g., words or emojis) and operators (e.g., −5, −4, . . . , +4, +5) that will be fed to the LSTM-based hint generator for guiding and ensuring that the user finds a one-time valid Dynamic Code (ODC) based on the knowledge of a HP.

The user authentication device 100 requires the user to set a list of ten password options including the HP's 4-symbolic items during the registration phase. Then, (s)he must find the ODC based on the HP knowledge from the randomized lists of password options. The randomization of the lists and the OVH item generated using the LSTM algorithm prevent the HP from being exposed to side-channel attacks.

FIG. 2 is a flow chart showing a method of registering a user with an authentication device according to an embodiment of the present invention. The method 200 shown in FIG. 2 is carried out by the user registration module 121 when executed by the processor 110 of the user authentication device 100 shown in FIG. 1.

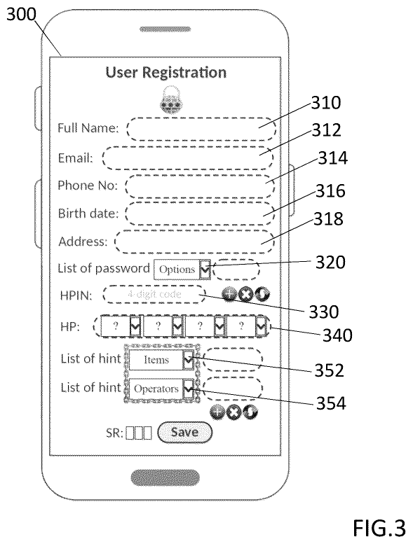

FIG. 3 shows a screen display of a user authentication device according to an embodiment of the present invention during user registration. The screen display 300 shown in FIG. 3 may be displayed by the user interface 116 of the user authentication device 100 while parts of the method 200 shown in FIG. 2 are carried out.

In step 202 of the method 200 shown in FIG. 2, the user authentication device 100 receives user input of identity information of the user. As shown in FIG. 3, the identity information of the user may be input into fields for full name 310, email 312, phone no. 314, birth date 316 and address 318. The list of identity information ( [symbol] _{id}) such as full name, email, phone number, birth date and address must be filled in by the user as the data source for checking the strength of the user's chosen HPIN and HP combinations. To prevent the user credentials from being cracked by guessing attacks, a strength-checking algorithm is used which analyzes the similarity rate between the user's chosen HPIN and HP and the possible sub-strings of the entered identity information and ensures that (s)he does not choose risky combinations that are guessable due to their similarity with the publicly available information. Since some of the users' identity information is publicly available, there is a high risk that attackers may collect and deploy them to guess the HPIN and/or HP.

In step 204 of the method 200 shown in FIG. 2, the user authentication device receives a user input of password options. As shown in FIG. 3, the password options 320 may be displayed as a drop-down list from which the user may select password options or entryways. This is a selective list called [symbol] ₚₒ that contains ten emojis as default options to be chosen by the user while entering the ODC. This idea also allows a user to personalize the [symbol] ₚₒ based on the preferred language (e.g., emojis or words). According to a psychological study using emojis in passwords makes them easier to remember for users than other combinations. Therefore, ten unique emojis are provided as default options which are changeable.

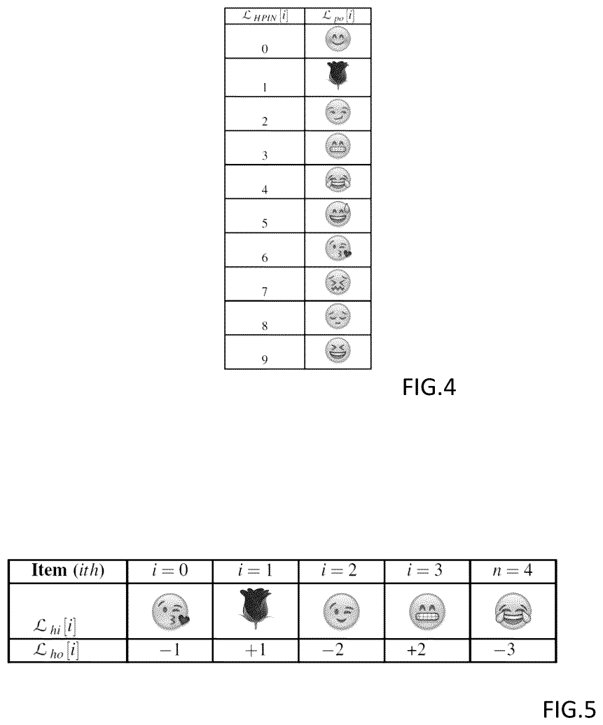

FIG. 4 is a table showing a list of default password options used in an embodiment of the present invention. As shown in FIG. 4, 10 numbers (0 to 9) correspond to 10 different emoji symbols.

After the user has selected the password options, in step 206 the user enters a hidden PIN (HPIN) and hidden passcode (HP). The HPIN is a 4-digit hidden code, which users must set and memorize during the registration phase. The HPIN is entered by the user into the HPIN space 330 of the display screen 300. The knowledge of HPIN digits will be used as the first factor indirectly to find the DPIN for activating the OVH item. During the authentication phase, the user authentication device 100 creates four randomized lists of (e.g., 0, . . . , 9) that user must find the ith items from them respectively during the authentication phase.

The selection of HP is entered by the user into the HP drop down boxes 340 of the display screen 300. The HP is a secret password combination, which consists of 4-symbolic elements (e.g., names, characters, and emojis) in any languages that a user has to set and memorize by defining the list of password options ( [symbol] ₚₒ), for example, the default list consists of ten emojis shown in FIG. 4, which must contain those four symbolic elements. The knowledge of the HP will be used by the user to find the ODC according to the OVH item produced using the LSTM-based GenAI algorithm. Here, the former states of the password entries are considered by the LSTM-based GenAI algorithm for reducing the risks of guessing attacks.

Once the user has input the HPIN and HP, in step 208, the strength of the HPIN and HP are checked and if the strength is insufficient, the method returns to step 206 and the user is prompted to input a new HPIN and/or HP. Step 208 may be implemented as an AI-based text mining algorithm, which is designed to make sure that user does not pick some parts of their publicly available information (e.g., birth date or home address) as their hidden credentials that prevents them from being cracked by guessing attacks. The user's data is fetched from a database or asked from the user during the registration phase, which will be mined to find any substring similarity with the HPIN or HP combinations.

In step 210, the user is prompted to select hint items and operations. These lists comprise of five default items ( [symbol] ₕᵢ) and their corresponding operators ( [symbol] ₕₒ) that are set randomly and can be changed by the user. Note that a hint item is selected randomly using the LSTM-based approach to remind the user to find an ODC. This mechanism ensures that the ODC is unique for each authentication process by guaranteeing its one-time validity. The hint items 352 and hint operators 354 are selected using drop down boxes.

FIG. 5 is a table showing a default list of hint items and operators used in an embodiment of the present invention. Two default lists of hint items ( [symbol] ₕᵢ) and corresponding operators ( [symbol] ₕₒ) are used as reminder options that help the user to find the one-time valid HP during the authentication phase. These elements are fed to the LSTM-based GenAI algorithm for randomly choosing a valid hint item, which is not the same as the past four authentication attempts.

Returning to FIG. 2, in step 212, the settings are saved in the data storage 130 of the user authentication device. When the target application is the Web 3.0 ecosystem, the encoding-storing procedure generates the hashed values of the HPIN and HP as well as the hidden string of password settings. Then, it saves the hashed values of HPIN and HP and hidden string along with other settings inside the local database.

The authentication stage requires a user to remember the knowledge of 4-digit HPIN and 4-symbolic HP items to find the one-time valid DPIN and ODC according to hint item's corresponding operator. According to a recent special publication 800-63B in October 2023, the National Institute of Standards and Technology (NIST) recommended requirements and guidelines for the safe deployment of memorized secrets (e.g., passwords and PINs) with a 6-digit length for randomly generated codes while it must be minimum eight digits long for user-chosen combinations, which make them difficult to guess or brute-force attack. For this reason, an eight symbolic-numeric long combination for the user-chosen hidden factors is used in the authentication device of the present disclosure. For the authentication process, the newly entered DPIN and hashed values of the HPIN and HP are used as the secret keys to verify the access to the password settings by performing a multi-key fully homomorphic encryption algorithm and extracting them via the steganography method. This procedure prevents attacks enabled by vulnerabilities (e.g., Inception or Downfall) through the CPUs and database systems from capturing the HPIN when they compromise the encrypted data. For the Web 2.0 application, the data are exchanged between the (D)App and cloud servers by performing the post-quantum hybrid key exchange algorithm (e.g., X25519Kyber768).

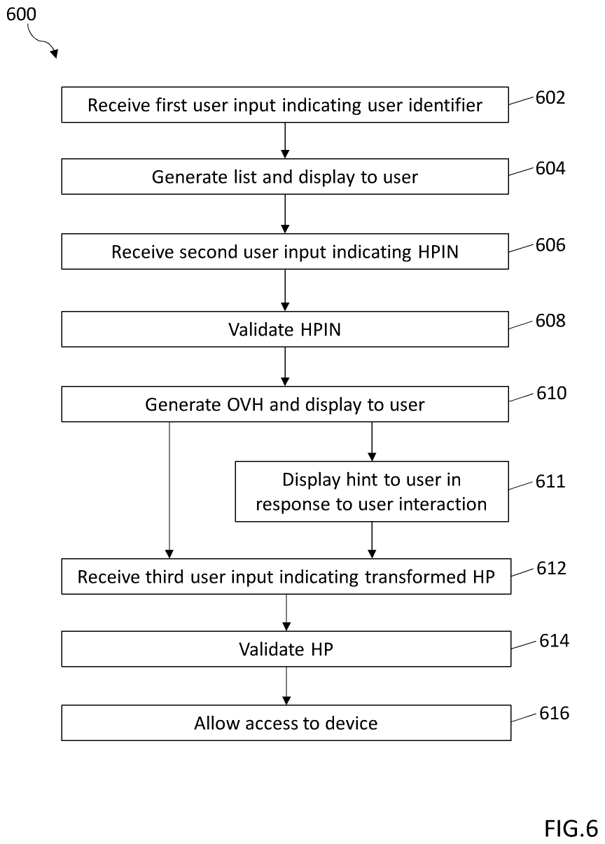

FIG. 6 is a flow chart showing a user authentication method according to an embodiment of the present invention. The method 600 shown in FIG. 6 is carried out by the user authentication device 100 shown in FIG. 1.

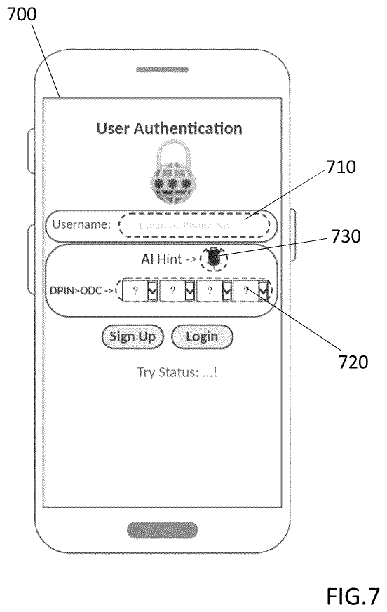

FIG. 7 shows a screen display of a user authentication device according to an embodiment of the present invention during user authentication. The screen display 700 shown in FIG. 7 may be displayed by the user interface 116 of the user authentication device 100 while parts of the method 600 shown in FIG. 6 are carried out.

In step 602, the user authentication device 100 receives a first user input which 15 indicates a user identifier of the user. As shown in FIG. 7, the screen display displays a username field 710 into which the user may enter a user identifier such as an email address or phone number. User must type her/his username (UN) via the general keyboard that is accessible for all apps (e.g., RAT spyware). The UN will be deployed as a search keyword to retrieve the other user's combinations, such as the hashed values of HPIN and HP and other settings from the local database stored in data storage 130.

In step 604, the list generation module 122 is executed by processor 110 of the user authentication device 100 to generate lists which are displayed to the user. Four lists of randomized password options named ( [symbol] ₚᵣₒ) are crafted that contain randomly picked items from the user's chosen ( [symbol] ₚₒ). In each list, the user enters an indication of the digit in the displayed list which corresponds to the HPIN digit. By remembering the HPIN, the user must find the digits of DPIN (e.g., each digit in HPIN code is the ith location in the [symbol] _{HPIN}[Rnd]. As shown in FIG. 7 the user enters the DPIN by choosing the value of i for each digit from drop down lists 720.

In step 606, the user interface 116 of the user authentication device 100 receives a second user input which indicates the HPIN. As described above, the second user input may comprise an indication of the location of each digit of the HPIN in the displayed lists.

In step 608, the PIN verification module 123 is executed by the processor 110 to validate the HPIN. If the HPIN is validated, the method moves to step 610.

In step 610, the hint generation module 124 is executed by the processor 110 of the user authentication device 100 to generate a one-time valid hint (OVH) and display the OVH to the user. Examples of OVH items are shown in FIG. 5. As shown in FIG. 7, an OVH item 730 is displayed on the screen display 700. The displayed OVH item is an emoji of a rose and from FIG. 5, it can be seen that in this example this symbol corresponds to +1.

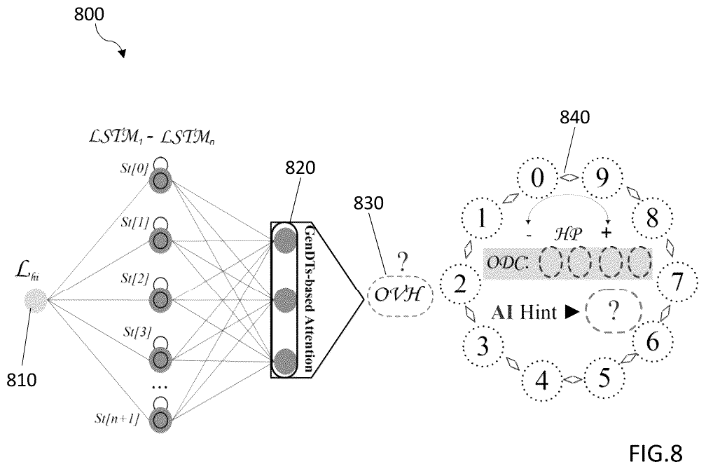

During step 610, a generative AI hint validator may be executed such as that shown in FIG. 8.

FIG. 8 shows a generative AI hint validator used in embodiments of the present invention.

Once the HPIN is verified successfully, the generative AI hint validator 800 retrieves the hint items and corresponding operators and considers the past states of user authentication attempts by processing via a LSTM-based hint validator algorithm. This technique utilizes the Generative-Decision Tree (GenDT) based attention mechanism 820 to ensure that the OVH item 830 chosen from the user's settings 810 has not been used in the last four states St[0] . . . St[4] and will not be utilized in the next four states as well. This is mainly because the number of default hint items are five and if the user sets more elements, the number of states will be increased accordingly. The OVH item 830 is randomly picked by the LSTM-based algorithm from the [symbol] ₕᵢ [i]. Note that a classical random selection approach based on probabilistic distribution is not deployed because after generating n hints based on the user's settings (the default n=5), there is a risk that in the St[n+1] state, it produces the identical item as state St[n], which must be different to ensure the security and consistency. As discussed above, the selected OVH corresponds to a transformation 840 on the HP. The transformation 840 takes a value from 0 to 9.

If the user has forgotten the hint item, they may interact with the displayed OVH item 730, for example by clicking on it and the method 600 will proceed to step 611 in which the transformation corresponding to the hint is displayed to the user. In this example the transformation corresponds to +1.

In step 612, the user inputs a third user input which corresponds to a transformed HP using the transformation indicated by the OVH item.

In step 614, the user authentication module 125 is executed by the processor 110 of the user authentication device 100 to authenticate the user. The authentication process may comprises comparing the user entered transformed HP with the stored HP for the user. This comparison may take place either by applying a reverse transformation to the user entered transformed HP and then comparing it to the stored HP or transforming the stored HP and then comparing the transformed stored HP with the transformed HP entered by the user.

In step 616, the user is allowed access to the device if the authentication in step 614 is successful.

A password recover option may be provided which allows a user to reset the settings once (s)he forgets it. Thus, a recovery mechanism may be provided, which sends a DPIN and an ODC to the email address or phone number that must be verified in less than a minute. When the combinations are received, the user should apply them to log into the account and update the HP and other settings.

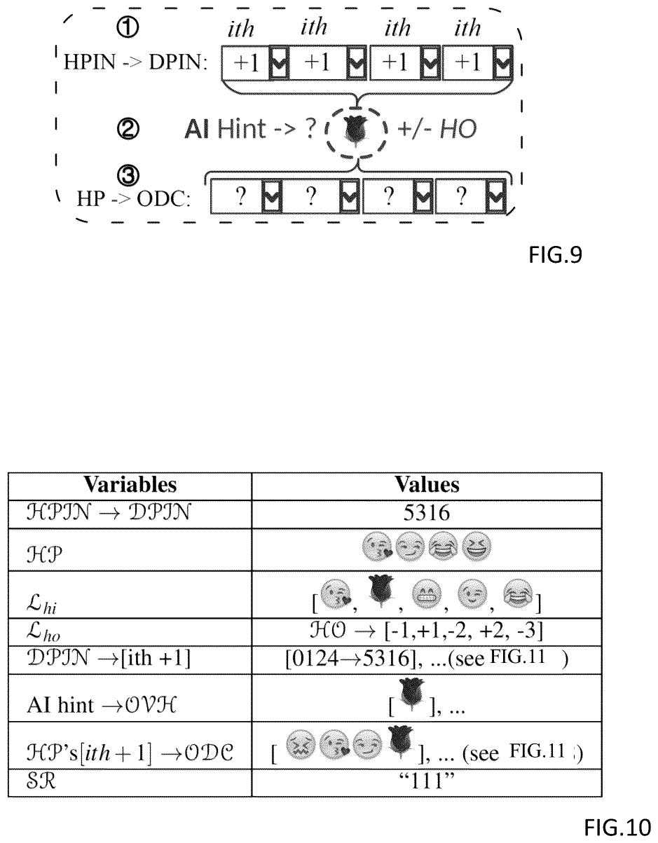

Example implementations of the method will now be described with reference to FIG. 9 to FIG. 13.

FIG. 9 shows an overview of the entry of hidden PIN (HPIN) and hidden passcode (HP) information in an embodiment of the present invention.

As shown in FIG. 9, to enter an indication of the HPIN, the user must convert the HPIN to a DPIN which involves determining the location of the relevant digit in a list and inputting an indication of the location (in the example shown it is the location in the list (ith)+1). Then the user is shown a hint item which indicates a transformation. The user then applies that transformation to their HP and input an indication of the transformed HP (ODC).

FIG. 10 is a table showing the authentication process for a first user.

As shown in FIG. 10, the first user has a HPIN which is 5316 and a HP which is a set of emojis as shown in the table.

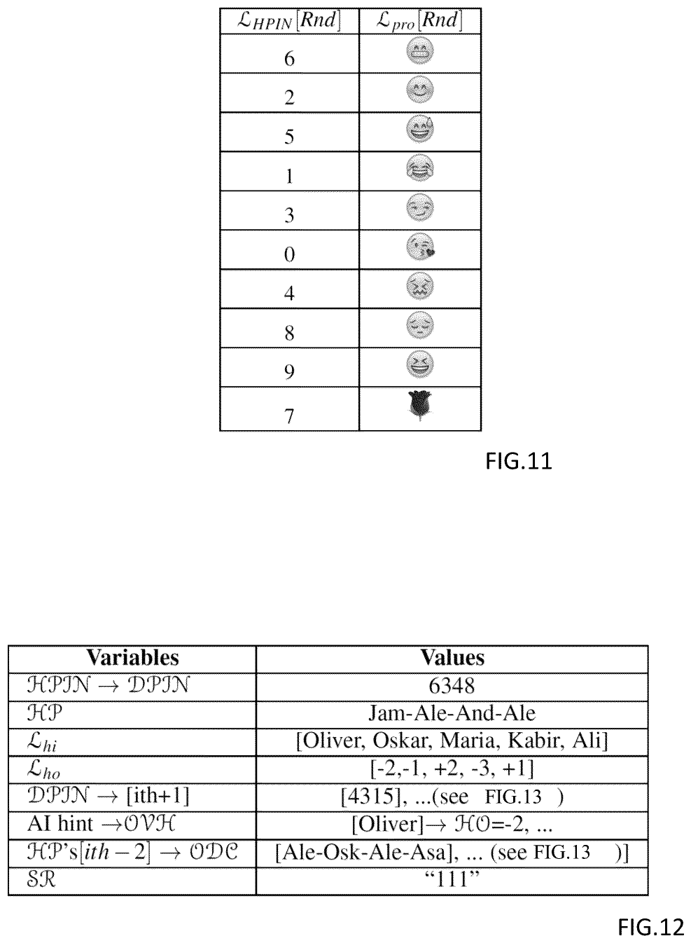

FIG. 11 shows two lists of one-time valid randomized options generated based on the first user's settings.

To generate the DPIN, the first user determines the ith+1 digit (where i is the digit of the HPIN) using the list shown in FIG. 11. Thus, 5316 becomes 0124 (the 6th, 4th, 2nd and 7th) digits in the list.

The hint item is a rose emoji which was randomly selected from the hint items ( [symbol] ₕᵢ) and corresponding operators ( [symbol] ₕₒ) corresponds to a transformation of +1. The first user then uses the table in FIG. 11 to their HP by moving +1 to get the sequence shown for the ODC and this is entered in as the transformed HP.

FIG. 12 is a table showing the authentication process for a second user. In this example, words are used in place of emojis.

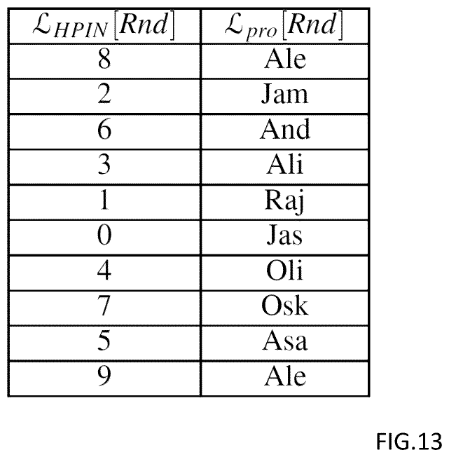

FIG. 13 shows two lists of one-time valid randomized options generated based on the second user's settings.

To generate the DPIN, the second user determines the ith+1 digit in the list shown in FIG. 13. Thus, 6348 becomes 4315. The hint item is Oliver which corresponds to a transformation of −2. The second user then uses the table in FIG. 13 to transform the HP (Jam-Ale-And-Ale) to (Ale-Osk-Ale-Asa) to get the sequence for the ODC and this is entered as the transformed HP.

In the following, existing U2D authentication schemes and an APT model that is highly likely to compromise users' accounts in (D)Apps are described. Then a comparison is made between existing schemes and the scheme of the present disclosure described above.

Technically, the primary goal of Web 3.0 platforms is to address critical problems of data ownership and control by giving power to netizens or communities. According to the Blockchain Council, (D)Apps have two types of architectures, including non-custodial (or self-custodial) and custodial platforms (e.g., crypto exchange systems), that control the users' security credentials differently. These platforms are still in the exploratory stages of early developments by technological activists (e.g., opensource DevOps engineers), where they hope to solve some of the significant shortcomings and setbacks of current centralized systems in IoE environments. The most prominent examples are the cryptocurrency exchanges, which are the hot spots of zero-day attacks due to storing and transacting enormous volumes of crypto assets. Below, the two types of security management architectures in (D)Apps are summarized:

i) Non-custodial (or self-custody) wallets allow netizens to have local control over their private (or secret) keys, which are stored in their devices to prove the ownership of their assets. Here, the private keys are generated based on users' security credentials (e.g., passwords or biometrics).

ii) Custodial wallets utilize a security management architecture, which allows third-party systems to control the netizens' private keys that are stored in their cloud servers.

These types of (D)Apps control netizens' assets by permitting them to manage their funds.

Considering the above security management architectures, the non-custodial (D)Apps are more prone to zero-day attacks as they are not monitored by centralized parties like custodial platforms. In practice, these (D)Apps deploy a distributed U2D authentication management architecture, which forms a system where the security credentials are saved locally on the user's device and securely synced via a device-to-device (D2D) end-to-end encryption algorithm within the linked blockchains (e.g., cloud servers) to ensure the security and integrity of data while being shared through IoE networks. The most common standard U2D schemes can be classified as follows:
SFA-a or -b: This is the most common and easiest form of the authentication scheme in which a user is required to set only one primary factor: a) a simple knowledge-based secret code (e.g., a PIN or an alphanumeric password), or b) a soft biometric trait (e.g., fingerprint or facial) to verify herself/himself through (D)Apps. In practice, the simplicity in implementation and easy to use deployment of knowledge-based schemes by various age ranges of end-users are the reasons that such security protocols are still the most popular mechanisms in payment systems (e.g., Visa cards) and other devices such as smartphones.
2FA-a or -b: This scheme requires the user to set two different factors on a trusted device by combining: a) knowledge-based combination (e.g., password or OTP verification mechanism (e.g., via an email or SMS) and b) soft biometric trait during the registration phase. Then, during the authentication phase, the user must enter two factors (e.g., fingerprint and OTP) to be granted permission to access his/her account. Although the 2FA-based mechanisms provide better attack resistance than the SFA-based algorithms by requesting two difficult-to-steal factors, it suffers from the device verification problem, which is beyond the user's control.
U2F-a or b: In this protocol, the user must set two physically different factors: a soft factor that can be a) knowledge-based combination or b) biometric trait and a hardware-based token (e.g., FIDO security key) during the registration phase. In the authentication phase, the user must connect the hardware secret key token to the device and enter the soft factor to verify her/himself through the U2D security protocol that are two reusable factors and can be stolen through more complex adversarial scenarios, i.e., performing an APT by installing spyware on the victim's device. In general, the U2F-based schemes are still one of the efficient security protocols, as they harden the possibility of accessing two factors simultaneously. Also, a recent study revealed that the user's security credentials through the hardware tokens could be captured by spyware and reused on the U2F-based mechanism without stealing its physical form.

In the literature, various APT groups exist that initiate covert access to their target IoE machines or infrastructures by performing side-channel attacks (e.g., phishing, code injection, or keylogging spyware). Below, the stages of an APT-based attack are briefly summarized.
(1) Infiltration: A user can be seduced by a phishing email or deepfake content via social media, or her/his device can be infected by spyware via an unpatched vulnerability like Downfall and Inception. One of the following side-channel adversarial (Adv) attacks could be executed to install RAT spyware through the victim user's device to compromise the account through (D)Apps.
Adv1. Shoulder-Surfing and Camera Recording: Living in the IoE environments, where digital gadgets are the inevitably connected machines around us, leaves the static (reusable) credentials at risk of being recorded by cameras or smartphones or watched by social engineers who have a clear view of the victim user while interacting with the device. After capturing the victim's U2D credentials, the malicious actor tries to install a RAT, e.g., by secretly stealing the device for a short time.
Adv2. Spyware (Keylogger/Stealer): This is a seemingly normal (D)App that is infected by malicious code to utilize a vulnerability (e.g., Downfall through Intel processors or Inception in AMD CPUs). Users may download such malicious (D)Apps from app stores by aiming to get normal services and granting them access permission to services through their devices, which can contain a RAT or install one covertly to collect sensitive data (e.g., screenshots, keystrokes, encrypted keys, and biometric templates).
Adv3. Guessing (Smudge, brute-force, or dictionary): If a conventional knowledge-based SFA-a is used as a security mechanism, there are three ways that attackers may try to guess and break it. The process of entering static (reusable) credentials by touching some spots on the screen or pressing the keys on the keypad through smart gadgets (e.g., multiple times for personal devices) leaves traceable smudges that could be considered guessing clues for an attacker if (s)he gets access to the victim device. Then, the adversary can try a few guesses based on the extracted features to bypass the U2D security protocol and eventually install a RAT, i.e., this attack is only effective on PIN, passcode, and pattern SFA based schemes. By deploying this attack, the adversary has more chance of estimating a correct combination by eliminating several ineffective possibilities since (s)he still does not know the order of letters, which needs a few guesses to be tried to bypass the security protocol successfully.
Adv4. Phishing: This is a kind of cybertrap in which attackers utilize a seductive way (e.g., deepfake videos or rewarding email) to trick victim users into thinking that they are invited to gain something valuable via email, SMS, or social media that put their sensitive information (e.g., passwords and banking credentials) at risks of being stolen. Eventually, if the victim user clicks on such phishing cybertraps, it can embed some backdoors that provide access to the network from several entry points; hence, they can continue to execute reconnaissance and set up a RAT covertly through the victim's device.
Adv5. Blackout and forgery: This is a situation in which a user can exhibit a loss of consciousness due to being a heavy sleeper or passing out because of being drugged or having an accident. In such a scenario, a malicious actor accessing the victim user's device and the hardware secret key token can bypass the biometrics-based U2D protocol and install a RAT. In this attack, the adversary utilizes the fundamental problem of openly accessible human biometric traits on the victim's body, which leaves them to be captured easily by anyone or recorded by smart gadgets, i.e., the user's fingerprints can be found on touched objects around them. Such soft biometric traits could be used to craft artificial objects with authentic features on them to be used for bypassing the U2D protocol when the victim user is not accessible in the blackout situation.
(2) Exploration and exfiltration: Once the RAT app is executed covertly, it monitors and collects the events (e.g., OTPs, keylogs or screenshots) and then encrypts and sends the real-time collected information to a command-and-control (C&C) server via an available network connection (e.g., direct, VPN/Proxy, or Tor).
(3) Intelligent data processing: The C&C server stores the received information and processes it by performing intelligent data (e.g., image/text) mining approaches according to the remote attacker's commands to discover the victim's security credentials. Then, it sends the extracted security credentials (e.g., passwords or OTPs) to the adversary.
(4) Maintenance: The attacker preserves the hidden RAT through an infected device for an extended period and sets or updates the commands through the C&C sever that helps collect the real-time security credentials until (s)he gets access to the victim's account and steals financial assets.

To validate a U2D security protocol, we consider the above defined APT model and technical constraints of state-of-the-art mechanisms, such as the static (reusable) nature of credentials and device authentication, while evaluating their performance. Still, there are vulnerabilities in existing schemes or the hardware infrastructures in IoE machines that allow attackers to devise active attacks to steal sensitive information. Hence, literature needs more accurate evaluation metrics to assess the performance of the state-of-the-art U2D protocols since the existing measures lack sufficient parameters to consider real world threats in IoE environments. In a recent empirical study conducted by Wang et al., the researchers have proven that most MFA schemes claim to provide efficient performance through verifiable security proofs in theory; however, in practice, they do not offer optimum performance when exposed to active attacks. Hence, we define five evaluation metrics in the following.
EM1. Perceived ease of use (Pₑᵤ): This is a significant factor in any technological usage, which affects the consumers' willingness to make regular use of the specific tool. In other words, using a specific U2D security protocol must be as easy as possible for consumers to gain a usability reputation and increase the possibility of becoming a regular protocol in society. Considering the above, we define this metric as the degree to which a user experiences that using a U2D security scheme needs less effort than others to be considered as a regular protocol. Let us assume that a U2D scheme requires a user to memorize n security credentials and some other settings (e.g., email address and hints) during the registration phase. Then, (s)he must remember those factors and take relevant actions on the device during the authentication process. Based on a guesswork assumption, a user might take an average of 0.5 second to remember a character from a password and an extra action to type it. The lower memorability cost and relevant actions needed to be taken by a user at each authentication attempt lead to a higher rate of Pₑᵤ score, which can be calculated as:

$${P}_{eu} = [ \frac{n}{[ \frac{n + v}{2} ] + [ {\sum }_{i = 1}^{n} {el}_{i} \cdot f + d ]} \cdot 100 ]$$

where n is the number of verifiable elements (e.g., characters) in a U2D security scheme, v denotes additional memorable items (e.g., an email address or a phone number), elᵢ is the i^{th} element of the credentials that require f actions to be taken considering the d additional remembering elements (e.g., viewing SMS). Note that in this formula, the

$$[ \frac{n + v}{2} ]$$

takes the memorability cost of remembering the knowledge-based elements under consideration. In addition,

$${\sum }_{i = 1}^{n} {el}_{i} \cdot f + d$$

is the number of elements to find and enter verifiable items as usability cost.
EM2. Robustness against reusability (R_{sc}): In general, each type of the U2D scheme described above requires some security credentials (e.g., password/PIN or biometrics) or objects (e.g., hardware secret key) to be verified that a user must possess and enter as the input factors. It implies that if an adversary captures the victim's entered credentials by recording keypress logs or screenshots, (s)he can bypass the U2D security protocol by claiming to be the original user. In such a scenario, the unreusability rate (R_{sc}) refers to the degree of dynamic factors in a particular U2D mechanism. Let us assume that n_{f} is the total number of factors a user must utilize to verify her/his access through a security scheme, and rp_{c} is the static (reusable) credentials during two consecutive authentication tries. Hence, the R_{sc} can be defined as:

$${R}_{sc} = [ ( 1 - \frac{{rp}_{c}}{{n}_{f}} ) \cdot 100 ]$$

EM3. Adversarial attack resistance (ARₜ): This measure is the resistance level of a specific protocol against the above-stated attacks, which can be expressed as:

$${AR}_{t} = [ \frac{{D}_{adv}}{{T}_{adv}} \cdot 100 ]$$

where the T_{adv} is the total number of evaluated attacks, and D_{adv} is the defeatable ones by a particular protocol. To analyze the resistance of a specific scheme, it is assumed that an adversary successfully performed the above five attacks during the user authentication so that they collect the victim's entered credentials.
EM4. Perceived usefulness for safety (Pᵤₛ): This metric represents the performance degree to which a user believes that the use of a U2D security protocol on a (D)App provides provable and acceptable security properties. We deploy the sample standard deviation Sd to evaluate this metric by computing the performance loss considering the three metrics (EM1-EM3).

$${S}_{d} = \sqrt{\frac{1}{n - 1} {\sum }_{i = 1}^{n} {( {x}_{i} \vert - \overline{μ} )}^{2}}$$

where, xᵢ={Pₑᵤ,R_{sc},ARₜ}, and n is the number of metrics considered. We define these evaluation metrics based on the empirical facts derived from the IoE environments. Therefore, if the S_{d} is low enough, Pᵤₛ equals the population mean

$$\overline{μ} = ( \frac{1}{3} {\sum }_{i = 1}^{3} {x}_{i} ) .$$

EM5. Users' preferability: Practically, the numerical analysis does not provide accurate evidence of the actual users' preference rate while experiencing a new U2D security protocol compared to existing ones. After testing the POC app, users participate in a survey in which they answer some questions about its simplicity, usability, and learning complexity.

### Analysis

EM1: To evaluate the Pₑᵤ for each scheme, we utilized the equation which calculates the number of memorability costs and usability efforts that a user needs to take to verify her/his access to the account. For the proposed method, the

$$[ \frac{8 + 5}{2} ] = 6.5$$

is the memorability cost of remembering the HPIN and HP. In addition,

$$[ ( {\sum }_{i = 1}^{8} 1 \cdot 1 ) + 1 ] = 9$$

is the number of actions required to find the DPIN and ODC during the authentication process. Considering these costs, we have a

$${P}_{eu} = [ \frac{8}{15.5} \cdot 100 ] = 52.$$

EM2: In practice, each U2D protocol applies one or more verifiable credentials due to the device-dependency of the entryway that can be exposed to the above five attacks (Adv1-Adv5) so that attackers can capture and imitate them to verify the access to the victim's account on behalf the original user. Since the proposed method requires a user to find and recognize three one-time valid/dynamic factors at each authentication attempt, we have a

$${R}_{sc} = [ \frac{3}{3} \cdot 100 ]$$

which is obtained using the equation above for R_{sc}. This score shows a zero similarity between two consecutive authentication processes via the proposed method.

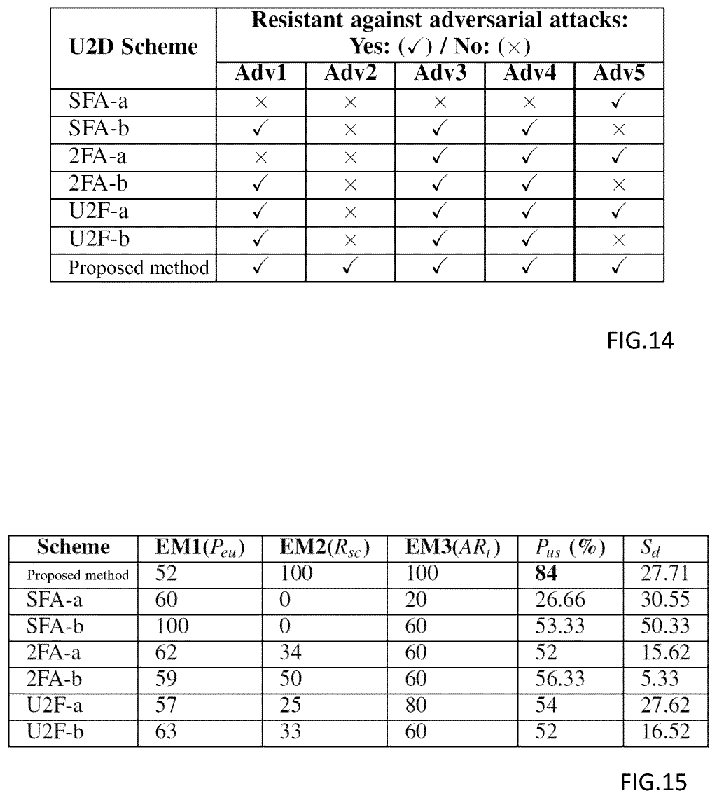

FIG. 14 is a table showing a comparison of Adversarial attack resistance score for different authentication methods.
EM3: By using the equation, we assess the ARₜ score of each scheme, considering the exposure of credentials against direct attacks in FIG. 14. For the method of the present disclosure, this score equals 100%, confirming that it prevents the attacker from compromising the account even if the user's entered credentials are entirely exposed to a successful APT-based attack.

FIG. 15 is a table showing a comparison of scores for different authentication methods.
EM4: To demonstrate the performance of the proposed method, the mean of the three calculated metrics (EM1-EM3) in above is calculated using the sample standard deviation method. As depicted in FIG. 15, the obtained scores of all the other schemes were calculated according to their memorability and usability costs. As a result, for the proposed scheme, the Pₑₛ=84%, which confirms that the performance rate is higher than other standard protocols.
EM5: To assess this metric, a questionnaire was designed using the Microsoft Forms platform, which comprises four questions and a link to an app configured to implement the POC app and 400 cryptocurrency traders who were active members of a trading group through WeChat were invited to test it and participate the survey. Note that we have considered several factors, including the learning complexity, usability for consumers, registration time, and authentication time according to the Likert Scale approach while designing this questionnaire. 47 (34 male and 13 female) participants took part in our software testing survey from 27 Jan. 2024 to 6 Feb. 2024, of which 91% ranked “Strongly agree” and “Agree” that shows consumers tend to utilize the proposed as a potential security protocol for protecting their accounts through (D)Apps, as well as 89% of respondents rated “Strongly agree” and “Agree” for securing their accounts on digital banking programs. In addition, 64% of participants ranked the learning complexity as “Very easy” and “Easy,” which confirms that despite the time-consuming registration settings (an average of 103 seconds) and authentication time (an average of 39 seconds), the suggested protocol is somehow easy to learn for most software testers.

In the following, various aspects of the proposed authentication method versus the standard U2D security protocols regarding prevention against attacks, and security against account compromise are discussed.

Nowadays, the popularity of Web 3.0 non-custodial (D)Apps, due to their anonymous infrastructures (e.g., providing hard-to-trace transactions), put them at risk of adversaries' targets, who can devise and perform several attacks to install an APT spyware that eventually lead to losing cryptocurrencies or financial assets. In fact, such an APT-based attack might happen in circumstantial situations that are very common these days. Because some U2D schemes apply static (reusable) factors and some others deploy dynamic codes (e.g., 2FA and U2F) to verify the user's access permission through an account, the reusability problem of credentials and device dependency of OTPs allow an APT attacker to bypass them by trying the stolen credentials.
Adv1. Shoulder-Surfing or Camera Recording: Assuming that after successfully performing this attack, the adversary captured or recorded the combinations entered by the victim user. In such a case, if the user applies the proposed method by finding the DPIN and ODC, these combinations cannot be used for the next authentication attempt. In the same scenario, the SFA-a and 2FAa are two techniques that expose the user's credentials so that the attacker can learn and apply them to install the RAT on the victim's device, while other schemes prevent such social engineering tricks.
Adv2. Spyware (Keylogger/Stealer): Assuming the victim's device has been infected by a malicious app or a RAT, a keylogger or data stealer, that already captured the user's credentials (or the encrypted secret keys or biometric templates) via backdoors through the CPUs (e.g., vulnerabilities Downfall or Inception 12). Also, in such a case, if the user applies the proposed method to access her account, the captured one-time valid combinations using the RAT spyware will contain the DPIN, ODC, and OVH that are no longer valid for the next authentication attempt. Note that the dynamic one-time valid combinations are always different because of the randomized selective entryways. On the other hand, the SFA-a, SFA-b, 2FA-a, and 2FA-b protocols are vulnerable to this attack due to the verification of knowledge-based, biometric templates or OTPs that the attacker can imitate by replicating the stolen credentials. Moreover, the spyware can leak the OTP received by SMS or email through the victim's device and block the network after sharing it with the attacker, which leads to remotely bypassing the 2FA-a and 2FA-b. In the U2F-a scheme, if the adversary gets a hold of the hardware token (e.g., secret key) and the victim's device along with the stolen credentials during the previous authentication process, then (s)he can eventually access the user's account. In practice, finding the hardware token and soft credentials simultaneously is a complex task for the adversaries. However, it is still possible to compromise the user's account for those who are close to the victim.
Adv3. Guessing (smudge, brute-force, or dictionary): Supposing that an adversary already accessed the user's device on which there are finger marks (or oil traces) on the keypad or screen after the (s)he utilized the proposed method for authentication. In this scenario, the attacker fails to discover the correct guess based on those traces by brute-forcing any potential combination or applying a dictionary of the most common ones since the proposed method applies dynamic security factors and blocks three consecutive wrong attempts. Similarly, the existing standard methods, such as SFA-b, 2FA-b, U2F-a, and U2F-b, deploy some static barometric factors (e.g., hardware token), which do not leave a trace on the victim device, strengthening it against this attack. On the other hand, the SFA-a and 2FA-a are vulnerable to smug attacks in which the adversary can narrow down the possibilities of guessing a correct combination according to the finger marks on the device's screen or keypad.
Adv4. Phishing: Assuming that a victim user was seduced by a phishing trap and executed a RAT covertly. In this case, if the user applies the proposed method to protect his/her account, the phishing trap can only capture the one-time valid credentials that are no longer reusable for the next authentication attempt. Although the SFA-b, 2FA-a, 2FA-b, U2F-a, and U2F-b schemes apply two independent difficult-to-steal factors, they expose the victim's device to be infected by a covert RAT. Also, the SFA-a is vulnerable to this attack because it deploys the static (reusable) primary factor during the authentication stage.
Adv5. Blackout or biometric forgery: Supposing a cryptocurrency owner installed a non-custodial wallet on his/her device and faced a blackout situation. In such a scenario, if the wallet is secured by the proposed scheme, an adversary gets access to the victim's device and cannot bypass it because of the dynamic nature of necessary factors. Similarly, if the SFA-a, 2FA-a, and U2F-a methods are applied, they can also resist this attack because they require a secret knowledge-based factor during the authentication stage. On the contrary, when the SFA-B, 2FA-b, and U2F-b schemes are deployed, they are susceptible to this attack because of the biometric openness to the public, which allows the attacker to bring the device close to the victim when (s)he is in a blackout situation, bypass the U2D scheme, and install the RAT.

Theoretically, standard 2FA (or U2F) schemes with an OTP through the (D)Apps or time-based password managers (e.g., Google Authenticator) are supposed to provide provable security and prevent account compromise against unauthorized remote access attacks. However, they have been proven to be insecure in specific scenarios, e.g., when the victim's device is infected by RAT spyware that can steal the OTPs, passwords or cryptocurrency wallet keys. This is mainly because of inappropriate storage of encrypted keys/templates and unsafe use of verifiable factors (e.g., biometrics or passwords). In this study, we assume that the user's device is subjected to an APT based attack, and a RAT was installed covertly. By considering a compromised device, where evaluated schemes deployed to protect the user's account, we discuss their highlights and limitations concerning the following circumstantial exposure of credentials.
Device-dependency and user's credential exposure: All the existing device-dependent schemes, such as app-based or SMS based 2FA, or token-based U2F-based protocols could be hijacked by the RAT spyware by stealing the security credentials from CPU or storage (e.g., encrypted keys, templates, passwords, keypress logs and screenshots), even when all the standard precautions were taken by the user. For instance, if the app-based 2FA does not show the OTP on the screen or send it via SMS, the APT-based attack discovers the victim user's email and password that the authenticator software was activated based upon such credentials, and the adversary can apply those to reset the settings of the victim on another device and eventually compromise the victim's account. In the same scenario, the proposed approach does not allow an attacker to compromise the user's account because when the RAT can only steal the DPIN and ODC combinations that are neither valid for the next authentication nor for the password recovery via another device. Since four lists of randomized options (entryways) are different at each authentication process, the user's chosen DPIN and ODC can only be authenticated once and using his/her device. This implies that if the adversary uses the same (D)App to try stolen DPIN and ODC combinations, the selective lists are randomized again, and these combinations are invalid, and (s)he cannot crack it without knowing the hidden settings memorized by the user.
Network dependency and OTP exposure: Technically, the SMS and email-based 2FA schemes need a network connection to receive the OTP through the user's device from a centralized server, which could be intercepted by a man-in-the-middle attack. However, time-based 2FA and U2F schemes addressed this problem by generating OTPs for multiple accounts that can function offline. Users of such schemes face a critical usability issue that risks getting locked out of their accounts if they lose their phones or hardware tokens. Surprisingly, a RAT can assist an attacker in resetting the user's settings if it discovers the recovery credentials set during the registration. The proposed approach also functions without requiring a network connection, and the exposure of the user's dynamic credentials cannot be reused to either compromise his/her account or reset the settings by a remote attacker. In addition to U2D security protocols, developers must advance the D2D schemes by implementing post-quantum-based public key exchange methods (e.g., X25519Kyber768Draft00, a hybrid key exchange for TLS 1.3) through (D)Apps due to the problem of weak randomness generation in classical cryptographic algorithms. For example, Bitcoin and Ethereum deploy the Elliptic Curve Digital Signature Algorithm (ECDSA), particularly “Secp256k1” to protect the transactions. Nevertheless, the leak of the nonce through the ECDSA implementation can put them at risk of the private key discovery by the Lenstra-Lenstra-Lov'asz (LLL) lattice basis reduction method. It implies that adversaries can craft side-channel traps (e.g., timing and lattice) to extract the private secret key of ECDSA and decrypt signed data. In practice, this security flaw could be the backdoor behind the address poisoning attack, which allows an adversary to embed his/her wallet address through the header of blocks and steal cryptocurrencies.

As described above, the present disclosure provides a user-to-device authentication scheme that requires a user to set and memorize a combination of the hidden 4-digit PIN and four symbolic passcodes to protect his/her access to the account through (D)Apps by finding dynamic one-time valid combinations, which prevents remote account compromise against an APT-based attack. To address the device-dependency and static (reusable) problems of security credentials, an LSTM-based hint generator that helps users find one-time valid codes based on the knowledge of the settings by ensuring that entered combinations are unique at each authentication attempt.

Whilst the foregoing description has described exemplary embodiments, it will be understood by those skilled in the art that many variations of the embodiments can be made within the scope and spirit of the present invention.

1. A user authentication method comprising:
receiving a first user input indicating a user identifier;
receiving a second user input indicating a hidden PIN, the hidden PIN comprising a combination of digits;
verifying the hidden PIN;
using the hidden PIN to retrieve an operator and a corresponding one-time valid hint item;
displaying the one-time valid hint item to the user;
receiving a third user input indicating a transformed hidden passcode, the transformed hidden passcode comprising a combination of symbolic items; and
authenticating the user if the transformed hidden passcode corresponds to a stored hidden passcode transformed by the operator, wherein the stored hidden passcode is associated with the user identifier.

2. The user authentication method according to claim 1, wherein using the hidden PIN to retrieve an operator and a corresponding one-time valid hint item comprises using the hidden PIN to generate an extraction secret key and using the extraction secret key to extract a set of operators and set of corresponding hint items and selecting the operator from the set of operators and the corresponding one-time valid hint item from the set of corresponding hint items.

3. The user authentication method according to claim 2, wherein using the hidden PIN to generate the extraction secret key comprises using the hidden PIN as a hash secret key to hash the user identifier and using the hashed user identifier as the extraction secret key.

4. The user authentication method according to claim 2, wherein the set of operators and the set of corresponding hint items are embedded as Unicode zero-width characters inside a hash value.

5. The user authentication method according to claim 2, wherein selecting the operator from the set of operators and the corresponding one-time valid hint item from the set of corresponding hint items comprises considering past states of user authentication.

6. The user authentication method according to claim 5, wherein considering past states of user authentication comprises using a Long Short-Term Memory based hint generator.

7. The user authentication method according to claim 5, wherein considering past states of user authentication comprises using a Generative-Decision Tree-based attention mechanism.

8. The user authentication method according to claim 1, further comprising generating a set of lists of randomized digits and wherein the second user input comprises a set of indications of an ith item in each list of the set of lists wherein it corresponds to a digit of the hidden PIN.

9. The user authentication method according to claim 1, further comprising displaying an indication of the operator to the user in response to a user interaction with the displayed hint.

10. A non-transitory computer readable carrier medium carrying processor executable instructions which when executed on a processor cause the processor to carry out a method according to claim 1.

11. A user authentication device comprising a processor, and program storage, the program storage storing computer program instructions operative by the processor to:
receive a first user input indicating a user identifier;
receive a second user input indicating a hidden PIN, the hidden PIN comprising a combination of digits;
verify the hidden PIN;
use the hidden PIN to retrieve an operator and a corresponding one-time valid hint item;
display the one-time valid hint item to the user;
receive a third user input indicating a transformed hidden passcode, the transformed hidden passcode comprising a combination of symbolic items; and
authenticate the user if the transformed hidden passcode corresponds to a stored hidden passcode transformed by the operator, wherein the stored hidden passcode is associated with the user identifier.

12. The user authentication device according to claim 11, wherein the program storage further stores computer program instructions operative by the processor to: use the hidden PIN to retrieve an operator and a corresponding one-time valid hint item by using the hidden PIN to generate an extraction secret key and using the extraction secret key to extract a set of operators and set of corresponding hint items and selecting the operator from the set of operators and the corresponding one-time valid hint item from the set of corresponding hint items.

13. The user authentication device according to claim 12, wherein using the hidden PIN to generate the extraction secret key comprises using the hidden PIN as a hash secret key to hash the user identifier and using the hashed user identifier as the extraction secret key.

14. The user authentication device according to claim 12, wherein the set of operators and the set of corresponding hint items are embedded as Unicode zero-width characters inside a hash value.

15. The user authentication device according to claim 12, wherein selecting the operator from the set of operators and the corresponding one-time valid hint item from the set of corresponding hint items comprises considering past states of user authentication.

16. The user authentication device according to claim 15, wherein considering past states of user authentication comprises using a Long Short-Term Memory based hint generator.

17. The user authentication device according to claim 15, wherein considering past states of user authentication comprises using a Generative-Decision Tree-based attention mechanism.

18. The user authentication device according to claim 11, wherein the program storage further stores computer program instructions operative by the processor to: generate a set of lists of randomized digits and wherein the second user input comprises a set of indications of an ith item in each list of the set of lists wherein it corresponds to a digit of the hidden PIN.

19. The user authentication device according to claim 11, wherein the program storage further stores computer program instructions operative by the processor to: display an indication of the operator to the user in response to a user interaction with the displayed hint.
